(19) United States
(12) Patent Application Publication
(10) Pub. No.: US 2025/0344050 A1
(43) Pub. Date: Nov. 6, 2025

(54) TRANSMITTING AIRCRAFT MOBILITY DATA TO A USER EQUIPMENT

(71) Applicant: QUALCOMM Incorporated, San Diego, CA (US)

(72) Inventors: Mingxi YIN, Beijing (CN); Kangqi LIU, San Diego, CA (US); Juan ZHANG, Beijing (CN); Qiaoyu LI, Beijing (CN); Ruiming ZHENG, Beijing (CN); Chao WEI, Beijing (CN); Hao XU, Beijing (CN)

(21) Appl. No.: 18/880,094

(22) PCT Filed: Aug. 26, 2022
(86) PCT No.: PCT/CN2022/115116

§ 371 Date: Dec. 30, 2024

(51) Int. Cl. H04W 8/08; H04W 56/00; H04W 64/00; H04W 84/06

(52) U.S. Cl. CPC H04W 8/08; H04W 56/0045; H04W 64/00; H04W 84/06

(57) ABSTRACT

Various aspects of the present disclosure generally relate to wireless communication. In some aspects, an aircraft surveillance function (ASF) in a New Radio (NR) network may transmit, to an automatic dependent surveillance broadcast (ADS-B) server, a request for aircraft mobility data, wherein the aircraft mobility data is associated with an aircraft configured to communicate with a user equipment (UE). The ASF may receive, from the ADS-B server and based at least in part on the request, the aircraft mobility data, wherein the aircraft mobility data indicates an aircraft number associated with the aircraft. The ASF may transmit, to the UE, the aircraft mobility data, wherein the aircraft mobility data indicates an aircraft NR identifier, and wherein the aircraft NR identifier is based at least in part on a mapping between the aircraft number and the aircraft NR identifier. Numerous other aspects are described.

### FIELD OF THE DISCLOSURE

Aspects of the present disclosure generally relate to wireless communication and to techniques and apparatuses for transmitting aircraft mobility data to a user equipment (UE).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at an aircraft surveillance function (ASF) in a New Radio (NR) network includes a memory and one or more processors, coupled to the memory, configured to: transmit, to an automatic dependent surveillance broadcast (ADS-B) server, a request for aircraft mobility data, wherein the aircraft mobility data is associated with an aircraft configured to communicate with a user equipment (UE); receive, from the ADS-B server and based at least in part on the request, the aircraft mobility data, wherein the aircraft mobility data indicates an aircraft number associated with the aircraft, and wherein the aircraft number is an aircraft flight number or an aircraft registration number; and transmit, to the UE, the aircraft mobility data, wherein the aircraft mobility data indicates an aircraft NR identifier, and wherein the aircraft NR identifier is based at least in part on a mapping between the aircraft number and the aircraft NR identifier.

In some implementations, an apparatus for wireless communication at a UE includes a memory and one or more processors, coupled to the memory, configured to: transmit, to an ASF in an NR network, an initial request for aircraft mobility data, wherein the aircraft mobility data is associated with an aircraft configured to communicate with the UE; receive, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an ADS-B server and the aircraft NR identifier, and wherein the aircraft number is an aircraft flight number or an aircraft registration number; and perform an action based at least in part on the aircraft mobility data.

In some implementations, a method of wireless communication performed by an ASF in an NR network includes transmitting, to an ADS-B server, a request for aircraft mobility data, wherein the aircraft mobility data is associated with an aircraft configured to communicate with a UE; receiving, from the ADS-B server and based at least in part on the request, the aircraft mobility data, wherein the aircraft mobility data indicates an aircraft number associated with the aircraft, and wherein the aircraft number is an aircraft flight number or an aircraft registration number; and transmitting, to the UE, the aircraft mobility data, wherein the aircraft mobility data indicates an aircraft NR identifier, and wherein the aircraft NR identifier is based at least in part on a mapping between the aircraft number and the aircraft NR identifier.

In some implementations, a method of wireless communication performed by a UE includes transmitting, to an ASF in an NR network, an initial request for aircraft mobility data, wherein the aircraft mobility data is associated with an aircraft configured to communicate with the UE; receiving, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an ADS-B server and the aircraft NR identifier, and wherein the aircraft number is an aircraft flight number or an aircraft registration number; and performing an action based at least in part on the aircraft mobility data.

In some implementations, a non-transitory computer-readable medium storing a set of instructions for wireless communication includes one or more instructions that, when executed by one or more processors of an ASF, cause the ASF to: transmit, to an ADS-B server, a request for aircraft mobility data, wherein the aircraft mobility data is associated with an aircraft configured to communicate with a UE; receive, from the ADS-B server and based at least in part on the request, the aircraft mobility data, wherein the aircraft mobility data indicates an aircraft number associated with the aircraft, and wherein the aircraft number is an aircraft flight number or an aircraft registration number; and transmit, to the UE, the aircraft mobility data, wherein the aircraft mobility data indicates an aircraft NR identifier, and wherein the aircraft NR identifier is based at least in part on a mapping between the aircraft number and the aircraft NR identifier.

In some implementations, a non-transitory computer-readable medium storing a set of instructions for wireless communication includes one or more instructions that, when executed by one or more processors of a UE, cause the UE to: transmit, to an ASF in an NR network, an initial request for aircraft mobility data, wherein the aircraft mobility data is associated with an aircraft configured to communicate with the UE; receive, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an ADS-B server and the aircraft NR identifier, and wherein the aircraft number is an aircraft flight number or an aircraft registration number; and perform an action based at least in part on the aircraft mobility data.

In some implementations, an apparatus for wireless communication includes means for transmitting, to an ADS-B server, a request for aircraft mobility data, wherein the aircraft mobility data is associated with an aircraft configured to communicate with a UE; means for receiving, from the ADS-B server and based at least in part on the request, the aircraft mobility data, wherein the aircraft mobility data indicates an aircraft number associated with the aircraft, and wherein the aircraft number is an aircraft flight number or an aircraft registration number; and means for transmitting, to the UE, the aircraft mobility data, wherein the aircraft mobility data indicates an aircraft NR identifier, and wherein the aircraft NR identifier is based at least in part on a mapping between the aircraft number and the aircraft NR identifier.

In some implementations, an apparatus for wireless communication includes means for transmitting, to an ASF in an NR network, an initial request for aircraft mobility data, wherein the aircraft mobility data is associated with an aircraft configured to communicate with the apparatus; means for receiving, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an ADS-B server and the aircraft NR identifier, and wherein the aircraft number is an aircraft flight number or an aircraft registration number; and means for performing an action based at least in part on the aircraft mobility data.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of air-to-ground (ATG) communications, in accordance with the present disclosure.

FIG. 5 is a diagram illustrating an example of an aircraft-based ATG extension, in accordance with the present disclosure.

FIGS. 6-13 are diagrams illustrating examples associated with transmitting aircraft mobility data to a UE, in accordance with the present disclosure.

FIGS. 14-15 are diagrams illustrating example processes associated with transmitting aircraft mobility data to a UE, in accordance with the present disclosure.

FIGS. 16-17 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

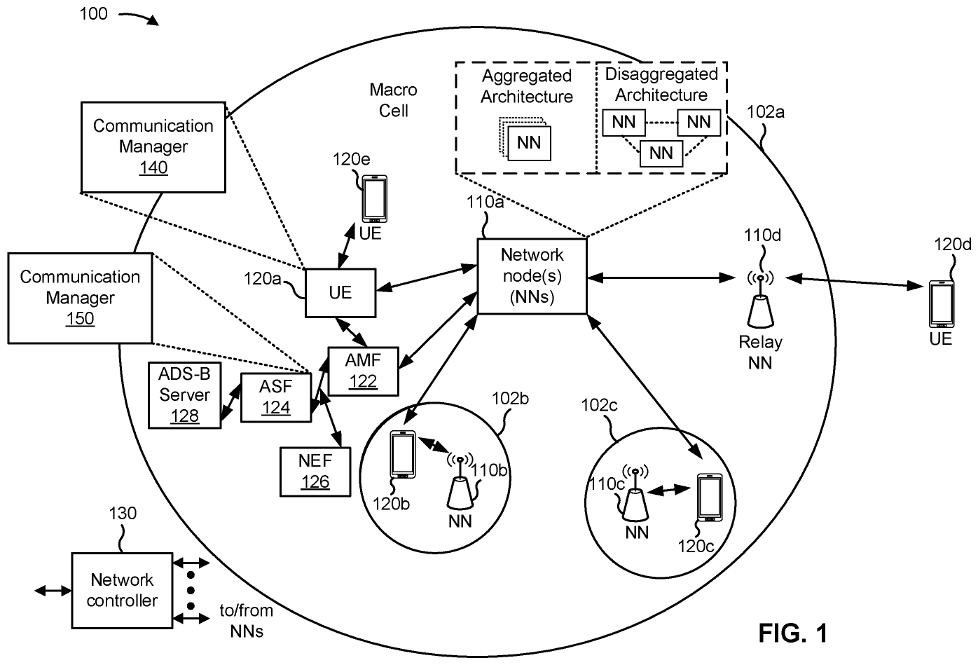

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a customer premises equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, an aircraft surveillance function (ASF) (e.g., ASF 124) in an NR network may include a communication manager 150. As described in more detail elsewhere herein, the communication manager 150 may transmit, to an automatic dependent surveillance broadcast (ADS-B) server, a request for aircraft mobility data, wherein the aircraft mobility data is associated with an aircraft configured to communicate with a UE; receive, from the ADS-B server and based at least in part on the request, the aircraft mobility data, wherein the aircraft mobility data indicates an aircraft number associated with the aircraft, and wherein the aircraft number is an aircraft flight number or an aircraft registration number; and transmit, to the UE, the aircraft mobility data, wherein the aircraft mobility data indicates an aircraft NR identifier, and wherein the aircraft NR identifier is based at least in part on a mapping between the aircraft number and the aircraft NR identifier. Additionally, or alternatively, the communication manager 150 may perform one or more other operations described herein.

In some aspects, a UE (e.g., UE 120) may include a communication manager 140. As described in more detail elsewhere herein, the communication manager 140 may transmit, to an ASF in an NR network, an initial request for aircraft mobility data, wherein the aircraft mobility data is associated with an aircraft configured to communicate with the UE; receive, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an ADS-B server and the aircraft NR identifier, and wherein the aircraft number is an aircraft flight number or an aircraft registration number; and perform an action based at least in part on the aircraft mobility data. Additionally, or alternatively, the communication manager 140 may perform one or more other operations described herein.

As indicated above, FIG. 1 is provided as an example. Other examples may differ from what is described with regard to FIG. 1.

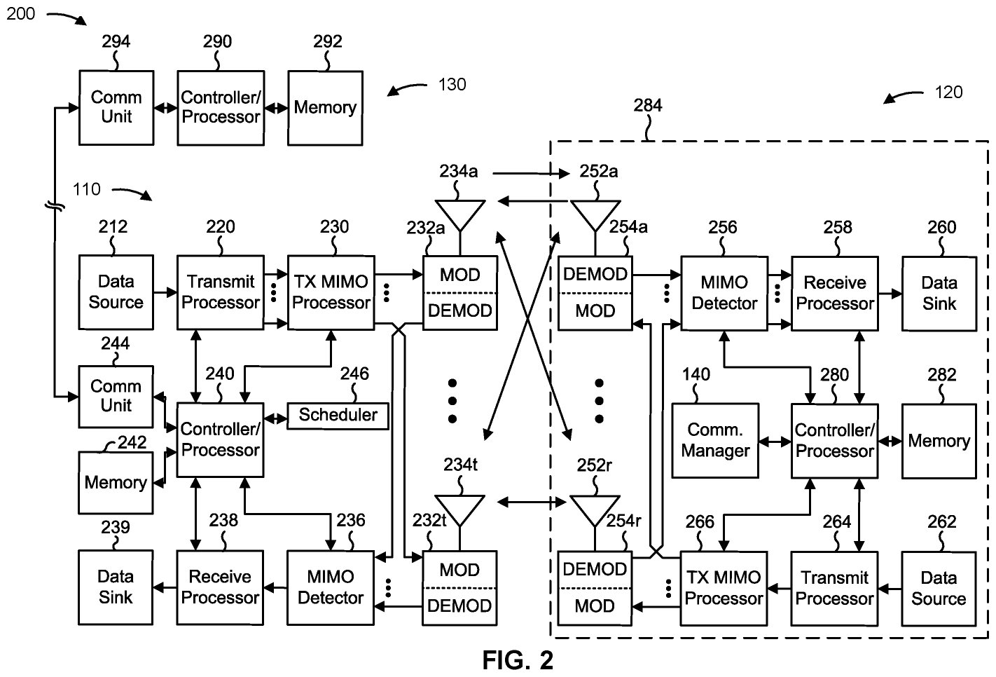

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

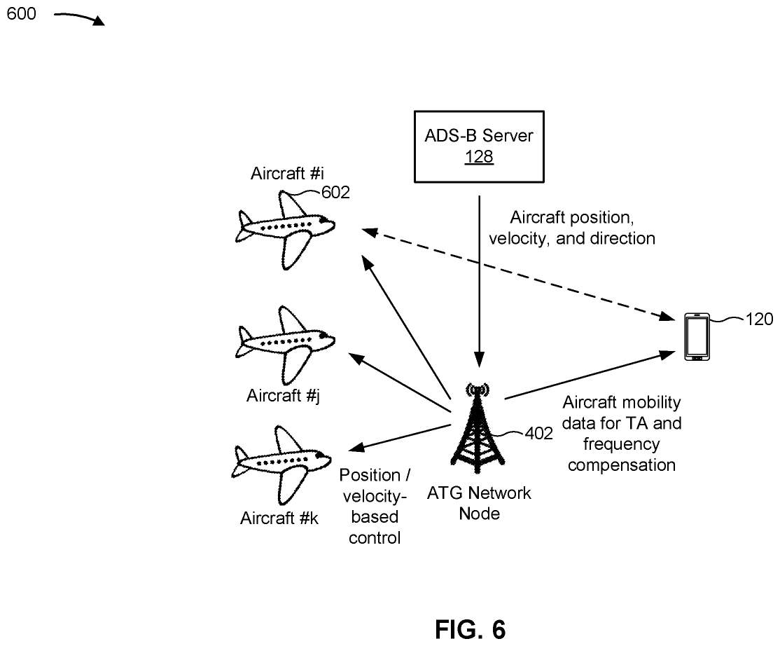

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-17).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-17).

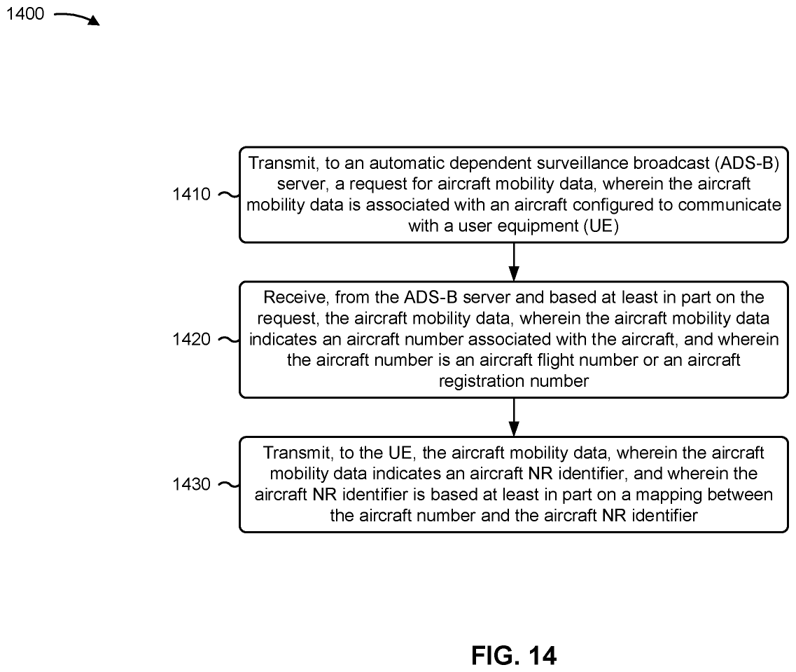

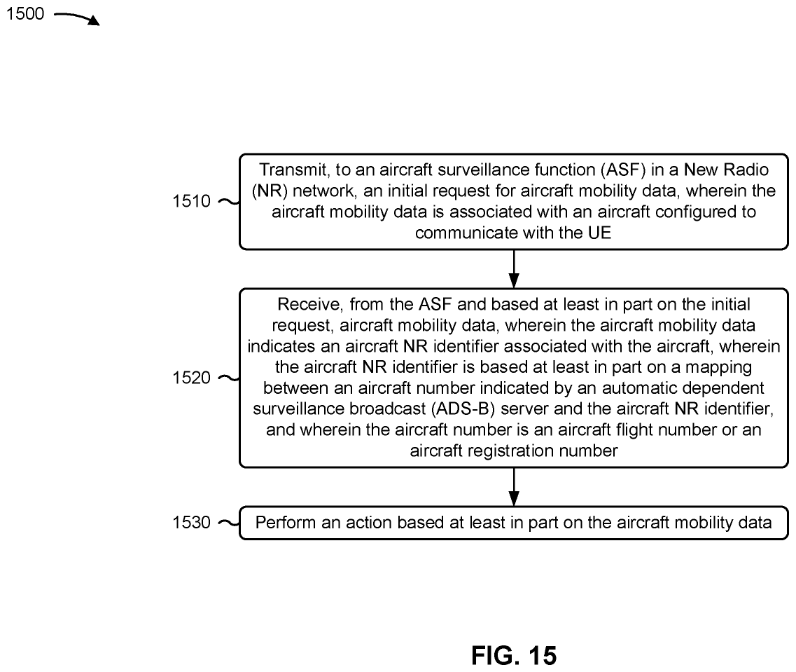

The controller/processor 240 of the network node 110, the controller/processor 280 of the UE 120, and/or any other component(s) of FIG. 2 may perform one or more techniques associated with transmitting aircraft mobility data to a UE, as described in more detail elsewhere herein. In some aspects, the ASF described herein includes one or more components of the base station 110 shown in FIG. 2 and/or includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, an ASF (e.g., ASF 124) in an NR network includes means for transmitting, to an ADS-B server, a request for aircraft mobility data, wherein the aircraft mobility data is associated with an aircraft configured to communicate with a UE; means for receiving, from the ADS-B server and based at least in part on the request, the aircraft mobility data, wherein the aircraft mobility data indicates an aircraft number associated with the aircraft, and wherein the aircraft number is an aircraft flight number or an aircraft registration number; and/or means for transmitting, to the UE, the aircraft mobility data, wherein the aircraft mobility data indicates an aircraft NR identifier, and wherein the aircraft NR identifier is based at least in part on a mapping between the aircraft number and the aircraft NR identifier. In some aspects, the means for the ASF to perform operations described herein may include, for example, one or more of transmit processor 220, TX MIMO processor 230, modem 232, antenna 234, MIMO detector 236, receive processor 238, controller/processor 240, memory 242, or scheduler 246. In some aspects, the means for the ASF to perform operations described herein may include, for example, one or more of antenna 252, modem 254, MIMO detector 256, receive processor 258, transmit processor 264, TX MIMO processor 266, controller/processor 280, or memory 282.

In some aspects, a UE (e.g., UE 120) includes means for transmitting, to an ASF in an NR network, an initial request for aircraft mobility data, wherein the aircraft mobility data is associated with an aircraft configured to communicate with the UE; means for receiving, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an ADS-B server and the aircraft NR identifier, and wherein the aircraft number is an aircraft flight number or an aircraft registration number; and/or means for performing an action based at least in part on the aircraft mobility data. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

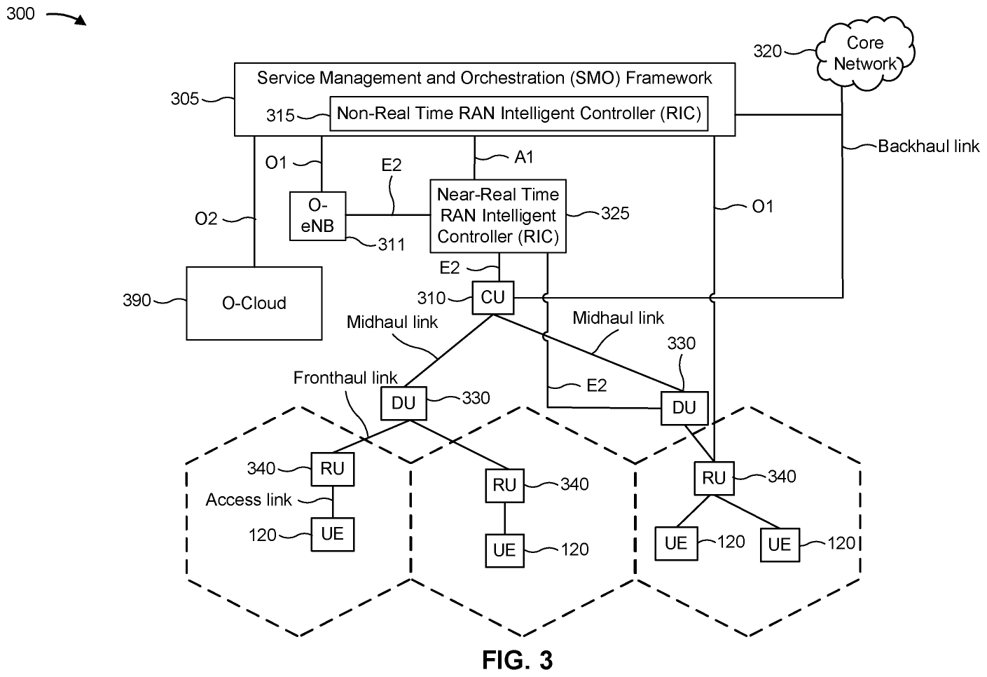

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an 01 interface) or via creation of RAN management policies (such as A1 interface policies).

As indicated above, FIG. 3 is provided as an example. Other examples may differ from what is described with regard to FIG. 3.

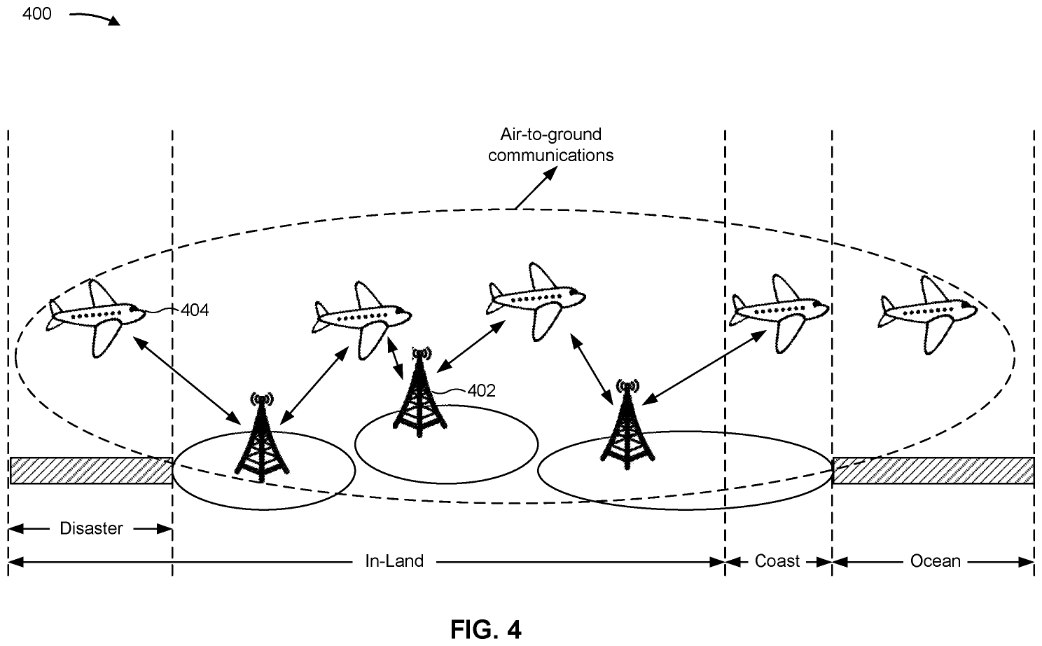

FIG. 4 is a diagram illustrating an example 400 of air-to-ground communications, in accordance with the present disclosure.

As shown in FIG. 4, air-to-ground (ATG) communications may allow ATG network nodes 402 on the ground to communicate with aircraft 404 and UEs associated with the aircraft 404 (e.g., UEs carried by passengers on the aircraft 404). An ATG network may be deployed inland (e.g., which may include disaster areas) and/or in coastal areas. In the ATG network, ATG network nodes 402 on the ground may be associated with up-tilting antennas. Aircraft 404 in the air may be associated with antennas that are located at an aircraft underside. UEs associated with the aircraft 404 may be connected to the ATG network via an onboard customer premises equipment (CPE) (e.g., in-cabin WiFi or small cell). ATG communications may provide various advantages over satellite communications, such as lower cost, higher throughput, and lower latency. ATG communications may support various traffic types, such as in-flight passenger communications (e.g., commercial flights and/or business aviation, which may include takeoff/landing and climb/descent scenarios), airline operation communications (e.g., aircraft maintenance, flight planning, and/or weather), and/or air traffic control (e.g., backup to systems in aviation licensed bands). ATG communications may serve as a back-up to systems in aviation licensed bands. ATG communications may enable in-flight connectivity.

As indicated above, FIG. 4 is provided as an example. Other examples may differ from what is described with regard to FIG. 4.

An ATG may be extended to serving terrestrial UEs by aircraft. In an aircraft-based ATG extension, commercial aircraft may be used to extend coverage for areas without terrestrial network nodes. A typical cruising altitude (e.g., 10 kilometers) of commercial aircraft may allow for a line-of-sight (LOS) propagation for over 200 kilometers. The density of commercial aircraft may vary by region but may generally be relatively dense during the daytime. For example, at least one aircraft may be visible within 50-100 kilometers in some areas.

The aircraft-based ATG extension may provide various advantages over a non-terrestrial network (NTN) deployment. The aircraft-based ATG extension does not require satellites to be launched, which may reduce a deployment cost (e.g., costs may be only for software upgrades based on existing/upcoming ATG CPEs) and achieve a faster time to market. The aircraft-based ATG extension may provide a better link budget due to an aircraft height of 10 kilometers versus a satellite height of 1000 kilometers.

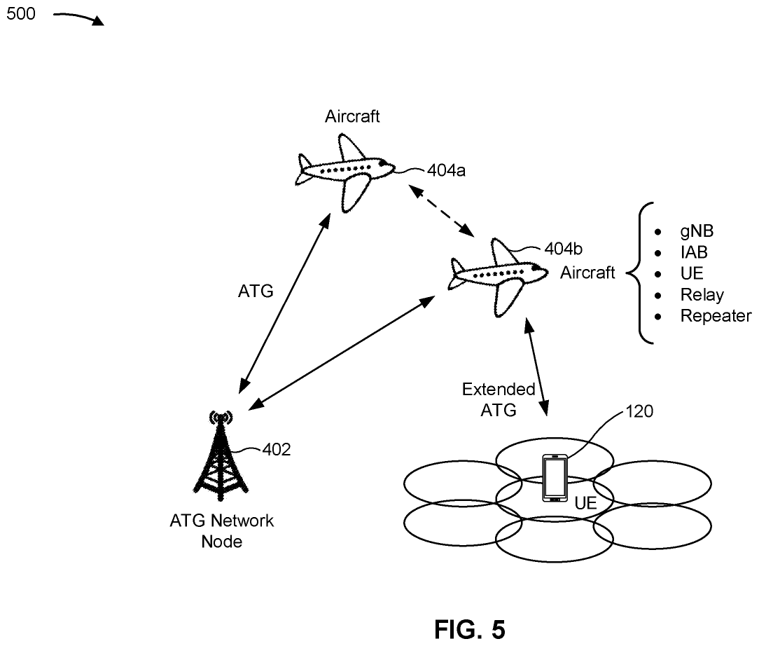

FIG. 5 is a diagram illustrating an example 500 of an aircraft-based ATG extension, in accordance with the present disclosure.

As shown in FIG. 5, a first aircraft 404a may communicate with a remote UE 120 on the ground. The remote UE 120 may be in an area without terrestrial network nodes. The first aircraft 404a may be associated with an ATG network node 402 (e.g., a base station), an IAB, a UE, a relay, or a smart repeater. The first aircraft 404a may communicate with a second aircraft 404b. The first aircraft 404a and the second aircraft 404b may both be able to communicate with the ATG network node 402 on the ground. The first aircraft 404a may be able to extend the coverage for the remote UE 120 on the ground.

As indicated above, FIG. 5 is provided as an example. Other examples may differ from what is described with regard to FIG. 5.

A positioning for aircraft as cellular nodes may be needed for an aircraft-based ATG extension but may be associated with various challenges, such as an uncertainty of an aircraft trajectory. The aircraft trajectory may be associated with a navigation error of up to 3.6 kilometers. An area navigation (RNAV) standard may require an aircraft to maintain a total system error of not more than 3.6 kilometers for 95% of a total flight time. The aircraft trajectory may be associated with trajectory temporary adjustments, such as high frequency temporary adjustments caused by departure delays and weather such as thunder clouds. The positioning for the aircraft may be determined using an NR location management function (LMF), but available resources may be insufficient for achieving a target accuracy for aircraft positioning. UEs may be within one kilometer of a network node, whereas commercial aircraft may be about 10 kilometers away from a network node. The positioning for the aircraft may be determined by sending global navigation satellite system (GNSS) signals using NR, but this requires a high throughput. Every aircraft may need to send a GNSS signal per half-second as required in aircraft surveillance systems, which may waste radio and power resources.

In various aspects of techniques and apparatuses described herein, a UE may transmit, to an ASF in an NR network, an initial request for aircraft mobility data. The aircraft mobility data may be associated with an aircraft (e.g., an aircraft UE/gNB) configured to communicate with the UE. The ASF may transmit, to an ADS-B server and based at least in part on the initial request, a request for the aircraft mobility data. The ASF may receive, from the ADS-B server and based at least in part on the request, the aircraft mobility data. The aircraft mobility data may indicate an aircraft number associated with the aircraft. The aircraft number may be an aircraft flight number or an aircraft registration number (e.g., a unique number assigned to a particular aircraft). The ASF may transmit, to the UE, the aircraft mobility data. The aircraft mobility data may indicate an aircraft NR identifier, where the aircraft NR identifier may be based at least in part on a mapping between the aircraft number and the aircraft NR identifier. The UE may perform an action based at least in part on the aircraft mobility data.

In some aspects, the positioning of the aircraft UE/gNB may be determined using the ADS-B server. The NR network may request, from the ADS-B server, the aircraft mobility data (or ADS-B data) associated with the aircraft UE/gNB. The aircraft mobility data may be identified by aircraft flight numbers (e.g., call signs) and registration numbers (e.g., tail numbers). One aircraft (or registration number) may serve different flights. NR aircraft nodes, such as a gNB, IAB, UE, relay, etc., may be identified using cellular system assigned identifiers in the NR network. The cellular system assigned identifiers may include a global gNB identifier, which may be based at least in part on a public land mobile network (PLMN) identifier and a gNB identifier. The cellular system assigned identifiers may include a UE identifier, which may be based at least in part on a global unique temporary identifier (GUTI) and a cell radio network temporary identifier (C-RNTI). The aircraft mobility data may be shared between the ADS-B server and the NR network, and aircraft flight/registration numbers associated with the aircraft mobility data may be mapped to cellular system assigned identifiers (e.g., NR identifiers, such as a gNB identifier or a UE identifier) in the NR network. The NR network may obtain, from the aircraft mobility data, position data, velocity data, direction data associated with the aircraft UE/gNB (or aircraft IAB/relay), etc., in the NR network. The NR network may determine the position data, velocity data, and direction data associated with the aircraft UE/gNB by using the aircraft mobility data received from an existing aircraft surveillance system (e.g., the ADS-B server). Reusing real-time aircraft mobility data from the existing aircraft surveillance system (e.g., the ADS-B server) may save radio and power resources for a gNB/UE that utilizes the aircraft mobility data.

FIG. 6 is a diagram illustrating an example 600 associated with transmitting aircraft mobility data to a UE, in accordance with the present disclosure.

As shown in FIG. 6, an ADS-B server 128 may transmit aircraft mobility data (e.g., aircraft position, velocity, and direction information) to an ATG network node 402 (e.g., ATG-gNB). The ATG network may perform a mapping of aircraft flight numbers and/or registration numbers associated with the aircraft mobility data to identifiers in an NR system. The ATG network node 402 may perform a position/velocity-based control of aircraft UEs/gNBs 602 (e.g., aircraft #i, aircraft #j, and aircraft #k) based at least in part on the aircraft mobility data. The ATG network node 402 may transmit, to a UE 120, the aircraft mobility data and corresponding identifiers (e.g., identifiers associated with the NR system). The UE 120 may perform a timing advance (TA) and frequency compensation with respect to an aircraft UE/gNB 602 (e.g., aircraft #i) based at least in part on the aircraft mobility data.

In some aspects, a position (as well as velocity and direction) associated with the aircraft UE/gNB 602 may be determined by reusing data from an existing aircraft surveillance system, such as ADS-B. In ADS-B, the aircraft UE/gNB 602 may broadcast its GNSS position, velocity, heading, flight number, etc., every half-second. ADS-B ground stations may collect aircraft mobility data (or ADS-B data) to air traffic control centers. Open servers for real-time global aircraft mobility data may be available. Reusing data for positioning of the aircraft UE/gNB 602 may efficiently make use of the existing high-performance aircraft positioning system, which may already have aircraft mobility data such as position, velocity, and direction.

In some aspects, ADS-B may provide access to weather and flight information. ADS-B may provide real-time precision, shared situational awareness, and advanced applications for pilots and controllers alike. The aircraft UE/gNB 602 may broadcast the GNSS position, velocity, heading, flight number, etc., by using ADS-B OUT equipment, which may use the 1090 MHz and 978 MHz frequencies, every half-second using a Mode S transponder. The aircraft UE/gNB 602 may also receive aircraft mobility data using ADS-B IN equipment. ADS-B ground stations may transmit aircraft mobility data to the air traffic control centers. The aircraft mobility data may indicate a flight identification (e.g., flight number), a 24-bit aircraft address (e.g., a globally unique airframe code), a position (e.g., latitude and longitude), a position integrity/accuracy (e.g., a global positioning system (GPS) horizontal protection limit), barometric and geometric altitudes, a vertical rate (e.g., a rate of climb/descent), a track angle and ground speed (e.g., velocity), an emergency indication, and/or a special position identification. Real-time ADS-B may be preferred for surveillance for air traffic control, and general aviation may be safer with ADS-B traffic, weather, and flight-information services.

As indicated above, FIG. 6 is provided as an example. Other examples may differ from what is described with regard to FIG. 6.

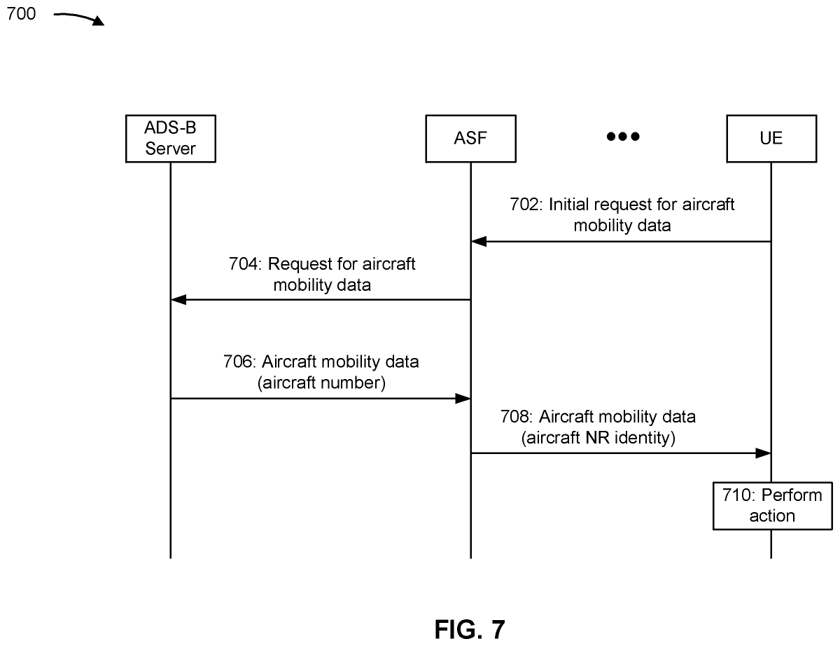

FIG. 7 is a diagram illustrating an example 700 associated with transmitting aircraft mobility data to a UE, in accordance with the present disclosure. As shown in FIG. 7, example 700 includes communication between an ASF (e.g., ASF 124), an ADS-B server (e.g., ADS-B server 128), and a UE (e.g., UE 120). In some aspects, the ADS-B server, and the UE may be included in a wireless network, such as wireless network 100.

As shown by reference number 702, the ASF (which may be associated with an application function or a third-party server) in an NR network may receive, from the UE, an initial request for the aircraft mobility data. The aircraft mobility data may be associated with an aircraft configured to communicate with the UE. The ASF may receive the initial request from the UE via an access and mobility management function (AMF) (not shown in FIG. 7) in the NR network. The initial request may originate at the UE. The UE may transmit the initial request to the ASF via a network node (not shown in FIG. 7) or the AMF. Alternatively, the initial request may originate at a network node or at the AMF. For example, the initial request may originate at the AMF in accordance with a schedule. The ASF, which may be associated with the application function or the third-party server, may be associated with a wired communication scheme (e.g., network cable or fiber optic, or virtual interface in software).

In some aspects, the initial request may indicate a reference position associated with the UE and a radius associated with the reference position. The radius may indicate a maximum range between the aircraft and the UE. The initial request may indicate an aircraft NR identifier associated with the aircraft. In some aspects, the ASF may receive the initial request from the UE based at least in part on an AMF notice to the UE indicating that the UE is within a defined distance from an edge of a terrestrial network. The UE may receive the AMF notice from the AMF. The ASF may receive, from the UE, the initial request in accordance with a request periodicity that is based at least in part on a downlink signal measurement.

As shown by reference number 704, the ASF may transmit, to the ADS-B server, a request for the mobility data. The ASF may transmit the request to the ADS-B server based at least in part on the initial request received at the ASF from the UE.

As shown by reference number 706, the ASF may receive, from the ADS-B server and based at least in part on the request, the aircraft mobility data. The aircraft mobility data may indicate an aircraft number associated with the aircraft. The aircraft number may be an aircraft flight number or an aircraft registration number. In some aspects, the ASF may filter the aircraft mobility data associated with the aircraft number based at least in part on the reference position and the radius associated with the reference position.

As shown by reference number 708, the ASF may transmit, to the UE, the aircraft mobility data, where the aircraft mobility data may indicate an aircraft NR identifier. The aircraft NR identifier may be based at least in part on a mapping between the aircraft number and the aircraft NR identifier. The ASF may transmit the aircraft mobility data to a network exposure function (NEF) (not shown in FIG. 7) in the NR network for the mapping between the aircraft number and the aircraft NR identifier. In some aspects, the ASF may transmit, to the AMF, the aircraft mobility data requested from the ADS-B server based at least in part on a schedule and not according to the initial request received from the AMF, the network node, or the UE.

In some aspects, the aircraft may be an aircraft UE, and the mapping between the aircraft number and the aircraft NR identifier may be based at least in part on a mapping between the aircraft registration number and an international mobile subscriber identity (IMSI) or a GUTI. In some aspects, the aircraft may be or may include an aircraft network node, and the mapping between the aircraft number and the aircraft NR identifier may be based at least in part on a mapping between the aircraft registration number and a global network node identifier. In some aspects, the aircraft may be an aircraft network node DU, and the mapping between the aircraft number and the aircraft NR identifier may be based at least in part on a mapping between the aircraft registration number, and a global network node identifier and a network node DU identifier. In some aspects, the aircraft may be an aircraft IAB, and the mapping between the aircraft number and the aircraft NR identifier may be based at least in part on a mapping between the aircraft registration number and a global IAB identifier. In some aspects, the aircraft may be an aircraft repeater, and the mapping between the aircraft number and the aircraft NR identifier may be based at least in part on a mapping between the aircraft registration number and a global repeater identifier. In some aspects, the aircraft may be an aircraft relay, and the mapping between the aircraft number and the aircraft NR identifier may be based at least in part on a mapping between the aircraft registration number and a global relay identifier.

As shown by reference number 710, the UE may perform an action based at least in part on the aircraft mobility data. For example, the UE may determine whether the UE is within a coverage area of the aircraft based at least in part on the aircraft mobility data. The UE may transmit a message based at least in part on a determination that the UE is within the coverage area of the aircraft. As another example, the UE may adopt a timing advance and frequency compensation based at least in part on the aircraft mobility data.

As indicated above, FIG. 7 is provided as an example. Other examples may differ from what is described with regard to FIG. 7.

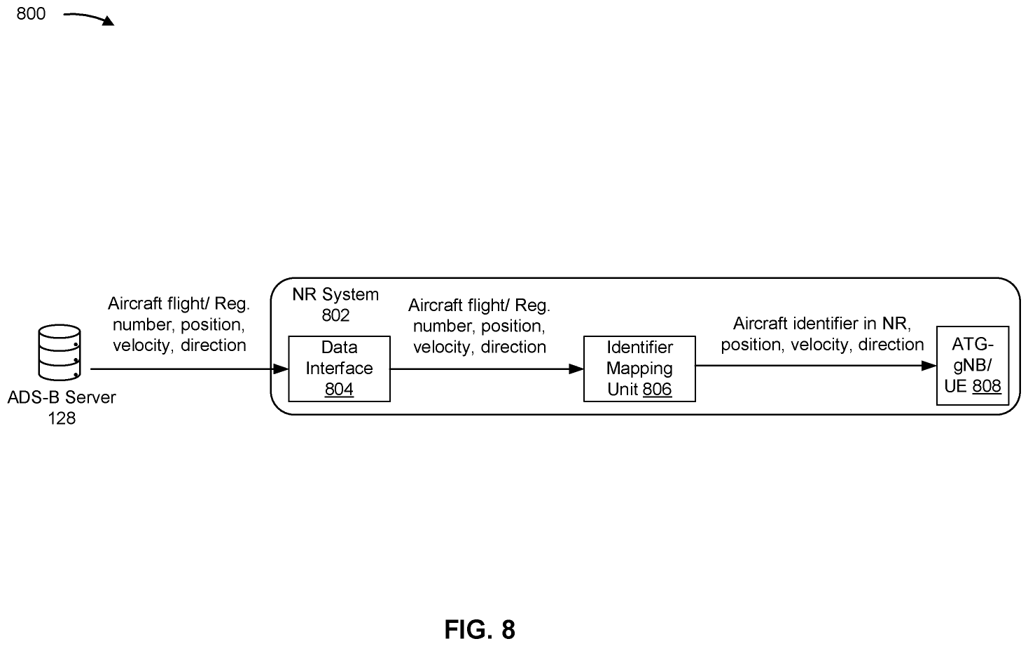

FIG. 8 is a diagram illustrating an example 800 associated with transmitting aircraft mobility data to a UE, in accordance with the present disclosure.

In some aspects, an NR system 802 may obtain, from an ADS-B system, aircraft mobility data. An ASF in the NR system 802 may support obtaining aircraft mobility data (or ADS-B data) from the ADS-B system. The NR system 802 may obtain the aircraft mobility data (e.g., position, velocity, and/or direction) from the ADS-B system. The aircraft mobility data may be associated with aircraft flight/registration numbers. The NR system 802 may perform a mapping between the aircraft flight/registration numbers and NR identifiers. For example, a network exposure function (NE) of the NR system 802 may determine which aircraft node (e.g., aircraft UE/gNB/IAB) is associated with the aircraft mobility data identified by the aircraft flight/registration numbers from the ADS-B system. Further, a UE may request the aircraft mobility data based at least in part on one or more triggering events.

As shown in FIG. 8, an ADS-B server 128 associated with the ADS-B system may transmit, to the NR system 802, an indication of an aircraft flight/registration number, and corresponding aircraft mobility data (e.g., position, velocity, and/or direction information). The indication may traverse through a data interface 804 associated with the NR system 802. The NR system 802 may perform, via an identifier mapping unit 806, an identifier mapping based at least in part on the aircraft flight/registration number, during which the NR system 802 may identify an aircraft UE/gNB identifier corresponding to the aircraft flight/registration number. The aircraft UE/gNB identifier may be associated with the NR system 802. The NR system 802 may identify the aircraft UE/gNB identifier using a lookup table, which may include a plurality of aircraft flight/registration numbers and corresponding aircraft UE/gNB identifiers. The NR system 802 may provide, to an ATG-gNB/UE 808 associated with the NR system 802, an indication of the aircraft UE/gNB identifier and the corresponding aircraft mobility data.

As indicated above, FIG. 8 is provided as an example. Other examples may differ from what is described with regard to FIG. 8.

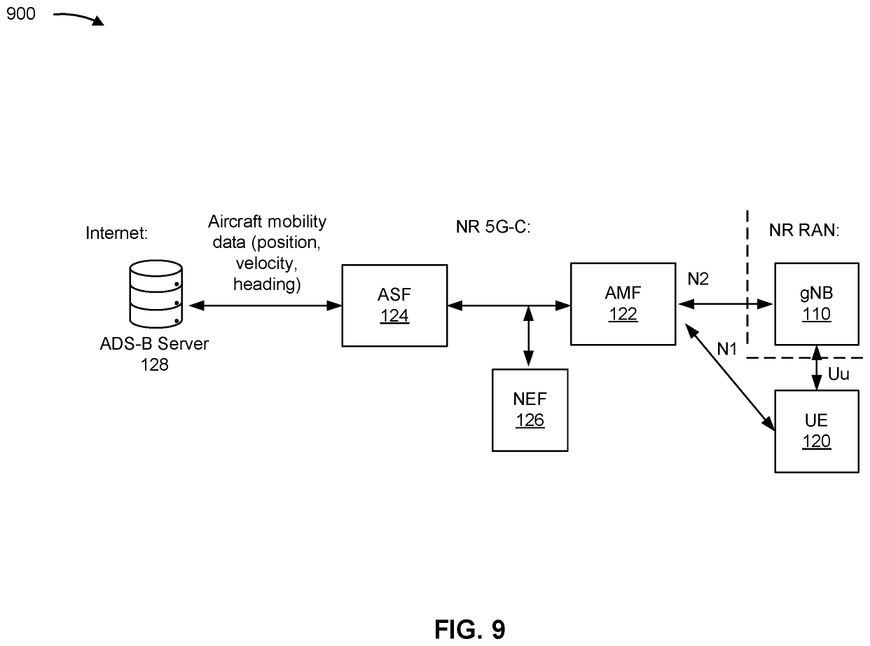

FIG. 9 is a diagram illustrating an example 900 associated with transmitting aircraft mobility data to a UE, in accordance with the present disclosure.

As shown in FIG. 9, an ASF 124 may be included in an NR system to support a collection of aircraft mobility data (or ADS-B data). The ASF 124 may be an application function, or the ASF 124 may be a third-party server. The ASF 124 may request, from an ADS-B server 128 associated with an ADS-B system, the aircraft mobility data, which may include information related to an aircraft's position, velocity, heading, etc. A UE/gNB 120/110 may transmit a request for the aircraft mobility data to the ASF 124. In other words, the ASF 124 may request the aircraft mobility data from the ADS-B server 128 based at least in part on the request received from the UE/gNB 120/110. The ASF 124 may obtain the aircraft mobility data from the ADS-B server 128, and the ASF 124 may respond to the UE/gNB 120/110 with the aircraft mobility data. The ASF 124 may respond to the UE/gNB 120/110 via an NEF 126 and an AMF 122, which may be based at least in part on an aircraft identifier mapping (e.g., a mapping between aircraft flight/registration numbers and NR identifiers, such as UE identifiers or gNB identifiers) which may occur between the ADS-B system and the NR system. The aircraft identifier mapping may occur in the NEF 126, which may be positioned between the ASF 124 and the AMF 122. The ASF 124, the NEF 126, and the AMF 122 may be associated with an NR 5G core (5G-C) network. The UE/gNB 120/110 may be associated with an NR RAN network.

As indicated above, FIG. 9 is provided as an example. Other examples may differ from what is described with regard to FIG. 9.

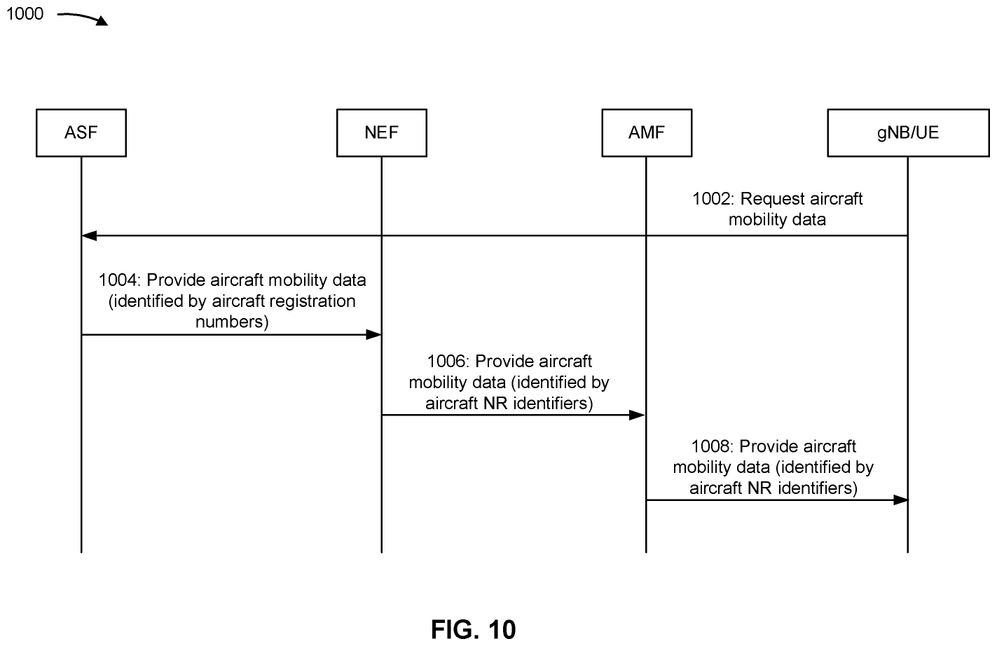

FIG. 10 is a diagram illustrating an example 1000 associated with transmitting aircraft mobility data to a UE, in accordance with the present disclosure. As shown in FIG. 10, example 1000 includes communication between an AMF (e.g., AMF 122), an ASF (e.g., ASF 124), an NEF (e.g., NEF 126), an ADS-B server (e.g., ADS-B server 128) (not shown), a UE (e.g., UE 120), and a network node (e.g., network node 110, which may be a gNB) (where the UE and the gNB are shown as combined in FIG. 10). In some aspects, the AMF, the ASF, the NEF, the ADS-B server, the UE, and the network node may be included in a wireless network, such as wireless network 100.

As shown by reference number 1002, the gNB/UE may transmit, to the ASF, a request for aircraft mobility data. The request may be transmitted by the AMF, the gNB, or the UE. The AMF may forward the request to the ASF for the gNB/UE. The ASF may be able to support aircraft mobility data (or ADS-B data). As shown by reference number 1004, the ASF may transmit aircraft mobility data to the NEF. The ASF may transmit the aircraft mobility data based at least in part on the request, or based at least in part on a regular schedule (e.g., the ASF may periodically transmit aircraft mobility data). The aircraft mobility data may be identified by aircraft flight/registration numbers. The ASF may receive the aircraft mobility data from an ADS-B server based at least in part on a connection between the ASF and the ADS-B server. As shown by reference number 1006, the NEF may transmit the aircraft mobility data to the AMF. At this point, the aircraft mobility data may be identified by aircraft NR identifiers. The NEF may determine the aircraft NR identifiers from the aircraft flight/registration numbers using a lookup table, which may include a plurality of aircraft flight/registration numbers and corresponding aircraft NR identifiers (e.g., aircraft UE/gNB identifiers). As shown by reference number 1008, the AMF may transmit the aircraft mobility data to the gNB/UE, where the aircraft mobility data may be identified by the aircraft NR identifiers. The gNB/UE may use the aircraft mobility data to perform an action (e.g., a TA and frequency compensation).

In some aspects, the request for aircraft mobility data from the AMF/gNB/UE to the ASF may indicate various types of optional information. The request may indicate reference positions and corresponding radii information. For example, the request may indicate a gNB/UE position and a maximum range connecting aircraft and gNB/UE. The ASF may provide the aircraft mobility data in regions, which may correspond to circles centered at reference positions with corresponding radii. The request may indicate NR identifiers of an aircraft whose aircraft mobility data is requested. For example, the request may indicate an IMSI or GUTI for an aircraft UE, or the request may indicate a global gNB identifier for an aircraft gNB. The ASF may provide aircraft mobility data that is associated with the NR identifiers indicated in the request. The NEF may map the NR identifiers in the request to aircraft flight/registration numbers in communication links between the AMF, the NEF, and the ASF. When the reference positions and corresponding radii information and/or the NR identifiers of the aircraft are not indicated in the request, the ASF may provide aircraft mobility data associated with global aircraft (e.g., aircraft traveling in a plurality of regions).

As indicated above, FIG. 10 is provided as an example. Other examples may differ from what is described with regard to FIG. 10.

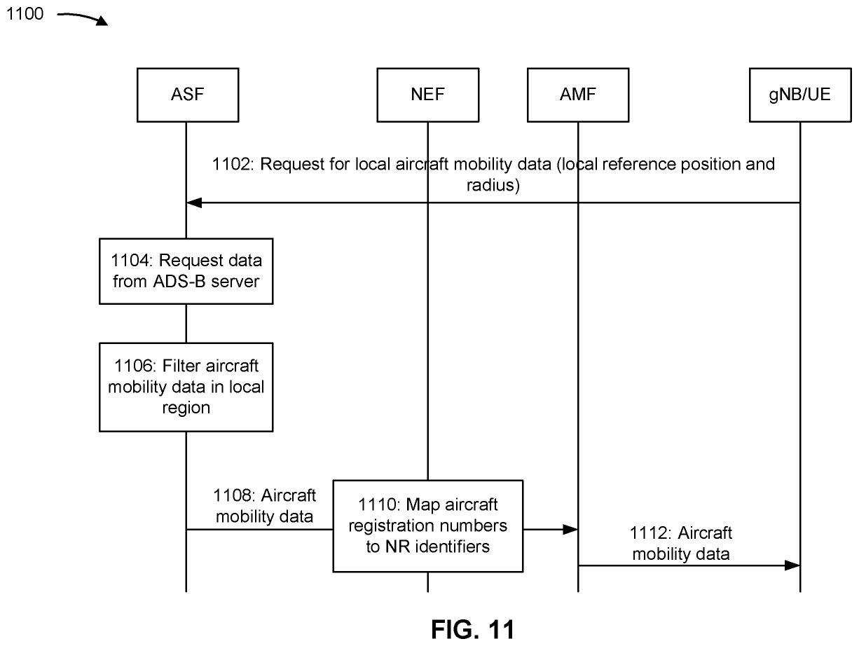

FIG. 11 is a diagram illustrating an example 1100 associated with transmitting aircraft mobility data to a UE, in accordance with the present disclosure. As shown in FIG. 11, example 1000 includes communication between an AMF (e.g., AMF 122), an ASF (e.g., ASF 124), an NEF (e.g., NEF 126), an ADS-B server (e.g., ADS-B server 128) (not shown), a UE (e.g., UE 120), and a network node (e.g., network node 110, which may be a gNB) (where the UE and the gNB are shown as combined in FIG. 11). In some aspects, the AMF, the ASF, the NEF, the ADS-B server, the UE, and the network node may be included in a wireless network, such as wireless network 100.

As shown by reference number 1102, based at least in part on a gNB/UE initiated procedure, the gNB/UE may transmit, to the ASF, a request for local aircraft mobility data. The request may also indicate a local reference position (e.g., a gNB/UE position) and radius information (e.g., a maximum range connecting an aircraft and the gNB/UE). The gNB/UE may transmit the request to the ASF, where the request may indicate information of a local region (e.g., a gNB/UE coverage area for the aircraft). Alternatively, the gNB/UE may transmit the request to the AMF, and the AMF may forward the request to the ASF. As shown by reference number 1104, the ASF may request aircraft mobility data (or ADS-B data) from an ADS-B server. The ASF may transmit the request to the ADS-B server based at least in part on the request received from the gNB/UE. As shown by reference number 1106, the ASF may filter the aircraft mobility data received from the ADS-B server, based at least in part on the local reference position and the radius. In other words, the ASF may filter the aircraft mobility data based at least in part on a requested region (e.g., a circle centered at a local reference position with the radius). As shown by reference number 1108, the ASF may transmit the local aircraft mobility data to the NEF. As shown by reference number 1110, the NEF may map an aircraft flight/registration number associated with the local aircraft mobility data to an NR identifier. As shown by reference number 1112, the NEF may transmit the local aircraft mobility data, which may be associated with the NR identifier, to the gNB/UE. In other words, the ASF may filter the aircraft mobility data according to the requested region, and the ASF may provide a result to the gNB/UE via the NEF and the AMF, where the NEF may map aircraft identifiers between the ASF and the AMF.

As indicated above, FIG. 11 is provided as an example. Other examples may differ from what is described with regard to FIG. 11.

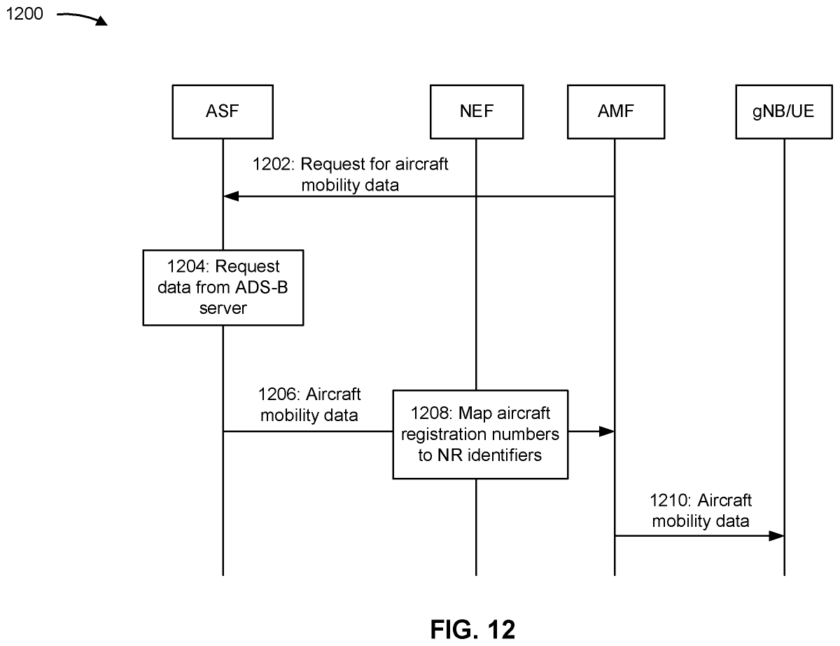

FIG. 12 is a diagram illustrating an example 1200 associated with transmitting aircraft mobility data to a UE, in accordance with the present disclosure. As shown in FIG. 12, example 1000 includes communication between an AMF (e.g., AMF 122), an ASF (e.g., ASF 124), an NEF (e.g., NEF 126), an ADS-B server (e.g., ADS-B server 128) (not shown), a UE (e.g., UE 120), and a network node (e.g., network node 110, which may be a gNB) (where the UE and the gNB are shown as combined in FIG. 12). In some aspects, the AMF, the ASF, the NEF, the ADS-B server, the UE, and the network node may be included in a wireless network, such as wireless network 100.

As shown by reference number 1202, based at least in part on an AMF-initiated procedure, the AMF may transmit, to the ASF, a request for aircraft mobility data. The AMF may request the aircraft mobility data from the ASF on a regular basis, or the AMF may request the aircraft mobility data from the ASF based at least in part on a triggering event. As shown by reference number 1204, the ASF may request aircraft mobility data (or ADS-B data) from an ADS-B server. The ASF may request the aircraft mobility data from the ADS-B based at least in part on the request received from the AMF.

Alternatively, based at least in part on an ASF-initiated procedure, the ASF may forward (or push) aircraft mobility data requested from the ADS-B server to the AMF according to a regular schedule. In other words, the ASF may periodically request the aircraft mobility data from the ADS-B server, and the ADS-B server may transmit the aircraft mobility data to the ASF, which the ASF may forward to the AMF.

As shown by reference number 1206, the ASF may transmit the aircraft mobility data to the NEF. As shown by reference number 1208, the NEF may map an aircraft flight/registration number associated with the aircraft mobility data to an NR identifier. As shown by reference number 1210, the NEF may transmit the aircraft mobility data, which may be associated with the NR identifier, to the gNB/UE.

As indicated above, FIG. 12 is provided as an example. Other examples may differ from what is described with regard to FIG. 12.

In some aspects, a mapping between aircraft flight/registration numbers and NR identifiers may be performed, where the mapping may involve accessing a lookup table that stores a plurality of aircraft flight/registration numbers and corresponding NR identifiers. An ADS-B server may only provide aircraft mobility data that is identified by aircraft flight numbers, in which case an ASF may need to map the aircraft flight numbers associated with the aircraft mobility data to aircraft registration numbers. An NEF may map the aircraft registration numbers associated with the aircraft mobility data to NR identifiers. In a reverse direction, the NEF may map NR identifiers to aircraft registration numbers. The NEF may perform the mapping based at least in part on an ASF-to-NEF-to-AMF communication link, or the NEF may perform the mapping based at least in part on an AMF-to-NEF-to-ASF communication link. In some aspects, for an aircraft UE, an aircraft registration number may be mapped to an IMSI/GUTI, or vice versa. For an aircraft gNB, an aircraft registration number may be mapped to a global gNB identifier, or vice versa. For an aircraft gNB-DU, an aircraft registration number may be mapped to the global gNB identifier plus a gNB-DU identifier, or vice versa. For an aircraft IAB, an aircraft registration number may be mapped to a global IAB identifier, or vice versa. For an aircraft repeater (e.g., smart repeater), an aircraft registration number may be mapped to a global repeater identifier, or vice versa. For an aircraft relay, an aircraft registration number may be mapped to a global relay identifier, or vice versa.

In some aspects, a UE may transmit a request for the aircraft mobility data to a gNB or directly to an AMF, which may request the aircraft mobility data from the ASF. The UE may transmit the request based at least in part on various triggering events. When the UE is about to leave a terrestrial network, the UE may be previously configured with aircraft mobility data to connect to an aircraft after a lost terrestrial network connection. The UE may transmit a message only when the aircraft is predicted to be in its coverage area, which may save power for the UE. The aircraft mobility data may indicate whether the aircraft is predicted to be in the coverage area. The UE may adopt TA and frequency compensation based at least in part on the aircraft mobility data. The UE may request the aircraft mobility data periodically from the ASF after receiving an AMF notice, which may indicate that the UE is on an edge of the terrestrial network. The UE may request the aircraft mobility data based at least in part on a request period, which may decrease when an RSRP measurement, RSRQ measurement, and/or signal-to-interference-and-noise ratio (SINR) of a downlink signal decreases.

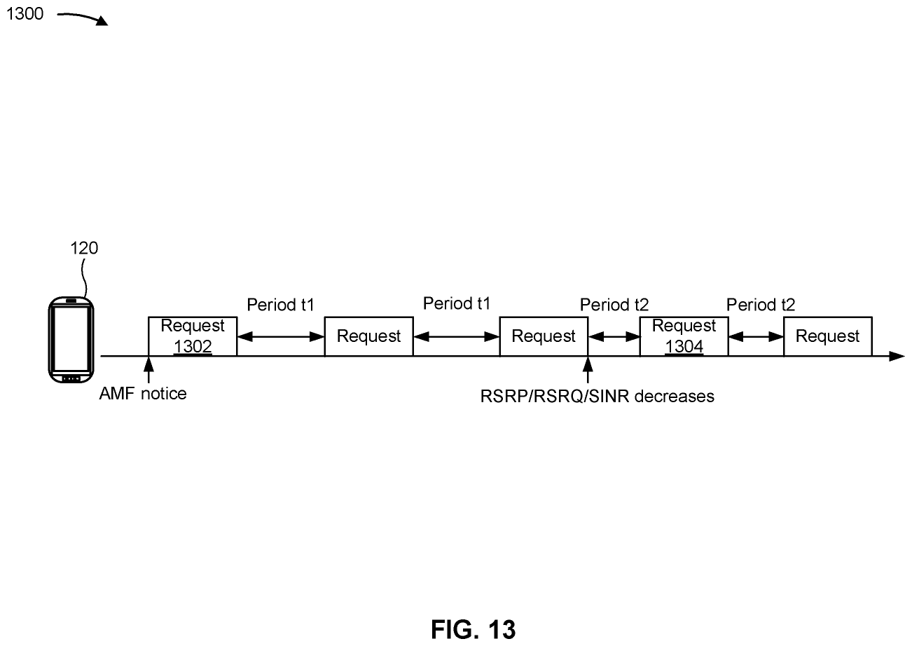

FIG. 13 is a diagram illustrating an example 1300 associated with transmitting aircraft mobility data to a UE, in accordance with the present disclosure.

As shown in FIG. 13, a UE 120 may receive an AMF notice from an AMF. The AMF notice may indicate that the UE 120 is on an edge of a terrestrial network. In other words, the AMF notice may indicate that the UE 120 is likely to leave the terrestrial network. After receiving the AMF notice, the UE 120 may request aircraft mobility data from an ASF in a periodic manner. For example, the UE 120 may transmit the request 1302 after every period t1.When an RSRP/RSRQ/SINR measurement of a downlink signal decreases, the UE 120 may transmit the request 1302 in accordance with a decreased periodicity (e.g., period t2). In other words, the UE 120 may wait a shorter period of time before transmitting a next request 1304. Based on the aircraft mobility data, the UE 120 may determine whether the UE 120 is still within coverage of an aircraft, and the UE 120 may only transmit messages when the aircraft is predicted to be in its coverage area to save power.

As indicated above, FIG. 13 is provided as an example. Other examples may differ from what is described with regard to FIG. 13.

FIG. 14 is a diagram illustrating an example process 1400 performed, for example, by an ASF in an NR network, in accordance with the present disclosure. Example process 1400 is an example where the ASF (e.g., ASF 124) in the NR network performs operations associated with transmitting aircraft mobility data to a UE.

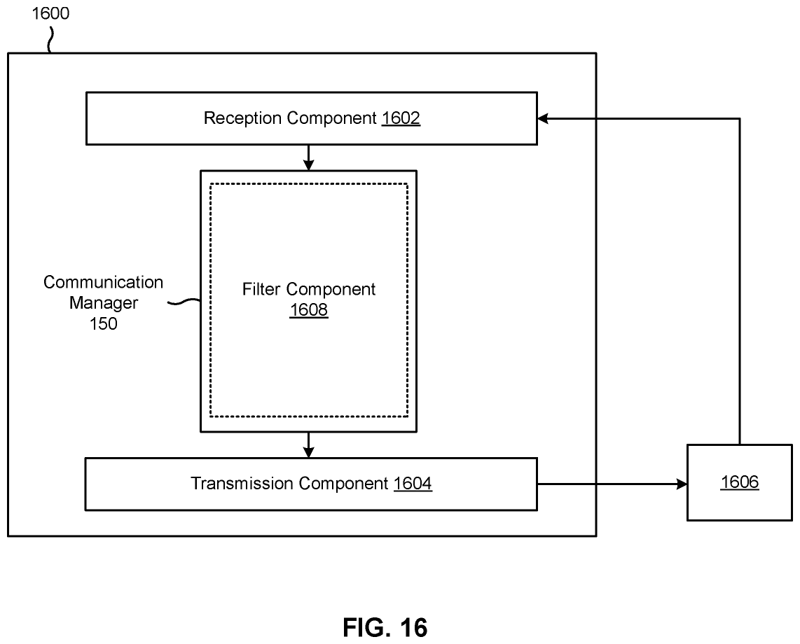

As shown in FIG. 14, in some aspects, process 1400 may include transmitting, to an ADS-B server, a request for aircraft mobility data, wherein the aircraft mobility data is associated with an aircraft configured to communicate with a UE (block 1410). For example, the ASF (e.g., using communication manager 150 and/or transmission component 1604, depicted in FIG. 16) may transmit, to an ADS-B server, a request for aircraft mobility data, wherein the aircraft mobility data is associated with an aircraft configured to communicate with a UE, as described above.

As further shown in FIG. 14, in some aspects, process 1400 may include receiving, from the ADS-B server and based at least in part on the request, the aircraft mobility data, wherein the aircraft mobility data indicates an aircraft number associated with the aircraft, and wherein the aircraft number is an aircraft flight number or an aircraft registration number (block 1420). For example, the ASF (e.g., using communication manager 150 and/or reception component 1602, depicted in FIG. 16) may receive, from the ADS-B server and based at least in part on the request, the aircraft mobility data, wherein the aircraft mobility data indicates an aircraft number associated with the aircraft, and wherein the aircraft number is an aircraft flight number or an aircraft registration number, as described above.

As further shown in FIG. 14, in some aspects, process 1400 may include transmitting, to the UE, the aircraft mobility data, wherein the aircraft mobility data indicates an aircraft NR identifier, and wherein the aircraft NR identifier is based at least in part on a mapping between the aircraft number and the aircraft NR identifier (block 1430). For example, the ASF (e.g., using communication manager 150 and/or transmission component 1604, depicted in FIG. 16) may transmit, to the UE, the aircraft mobility data, wherein the aircraft mobility data indicates an aircraft NR identifier, and wherein the aircraft NR identifier is based at least in part on a mapping between the aircraft number and the aircraft NR identifier, as described above.

Process 1400 may include additional aspects, such as any single aspect or any combination of aspects described below and/or in connection with one or more other processes described elsewhere herein.

In a first aspect, the ASF is associated with an application function or a third-party server.

In a second aspect, alone or in combination with the first aspect, process 1400 includes receiving, from an AMF in the NR network, an initial request for the aircraft mobility data, wherein the initial request originates at one of the UE, a network node, or the AMF, and the request is transmitted to the ADS-B server based at least in part on the initial request received at the ASF.

In a third aspect, alone or in combination with one or more of the first and second aspects, the initial request indicates a reference position associated with the UE and a radius associated with the reference position, and the radius indicates a maximum range between the aircraft and the UE.

In a fourth aspect, alone or in combination with one or more of the first through third aspects, the initial request indicates the aircraft NR identifier associated with the aircraft.

In a fifth aspect, alone or in combination with one or more of the first through fourth aspects, the initial request is received from the UE based at least in part on an AMF notice to the UE indicating that the UE is within a defined distance from an edge of a terrestrial network, and the initial request is received in accordance with a request periodicity that is based at least in part on a downlink signal measurement.

In a sixth aspect, alone or in combination with one or more of the first through fifth aspects, process 1400 includes filtering the aircraft mobility data associated with the aircraft number based at least in part on a reference position and a radius associated with the reference position.

In a seventh aspect, alone or in combination with one or more of the first through sixth aspects, process 1400 includes transmitting the aircraft mobility data to an NEF in the NR network for the mapping between the aircraft number and the aircraft NR identifier.

In an eighth aspect, alone or in combination with one or more of the first through seventh aspects, process 1400 includes transmitting, to an AMF in the NR network, the aircraft mobility data requested from the ADS-B server based at least in part on a schedule and not according to an initial request for the aircraft mobility data received from one of the AMF, a network node, or the UE.

In a ninth aspect, alone or in combination with one or more of the first through eighth aspects, process 1400 includes receiving, from an AMF in the NR network, an initial request for the aircraft mobility data, wherein the initial request originates at the AMF according to a schedule.

In a tenth aspect, alone or in combination with one or more of the first through ninth aspects, the aircraft is an aircraft UE, and the mapping between the aircraft number and the aircraft NR identifier is based at least in part on a mapping between the aircraft registration number and an IMSI or a GUTI; the aircraft is an aircraft network node, and the mapping between the aircraft number and the aircraft NR identifier is based at least in part on a mapping between the aircraft registration number and a global network node identifier; the aircraft is an aircraft network node DU, and the mapping between the aircraft number and the aircraft NR identifier is based at least in part on a mapping between the aircraft registration number, and a global network node identifier and a network node DU identifier; the aircraft is an aircraft IAB, and the mapping between the aircraft number and the aircraft NR identifier is based at least in part on a mapping between the aircraft registration number and a global IAB identifier; the aircraft is an aircraft repeater, and the mapping between the aircraft number and the aircraft NR identifier is based at least in part on a mapping between the aircraft registration number and a global repeater identifier; or the aircraft is an aircraft relay, and the mapping between the aircraft number and the aircraft NR identifier is based at least in part on a mapping between the aircraft registration number and a global relay identifier.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a UE, in accordance with the present disclosure. Example process 1500 is an example where the UE (e.g., UE 120) performs operations associated with transmitting aircraft mobility data to a UE.

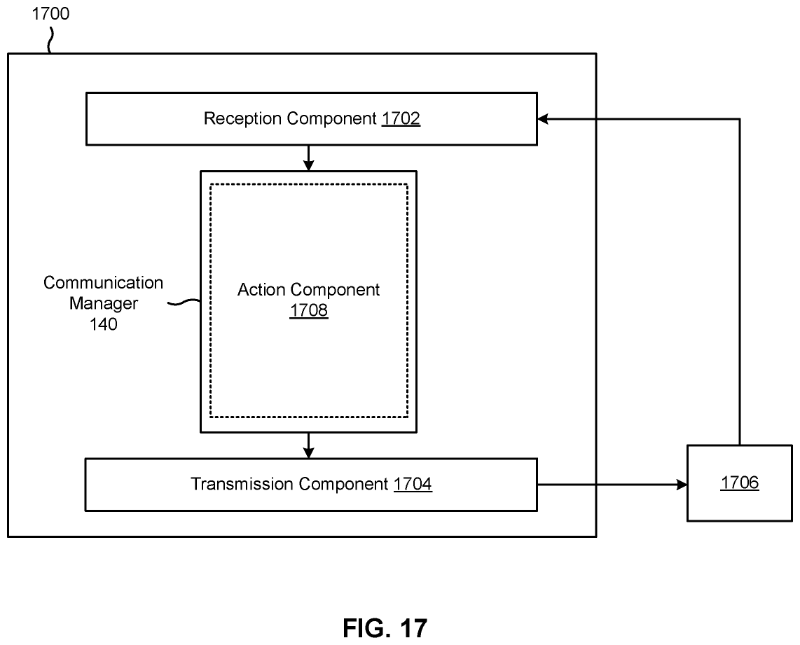

As shown in FIG. 15, in some aspects, process 1500 may include transmitting, to an ASF in an NR network, an initial request for aircraft mobility data, wherein the aircraft mobility data is associated with an aircraft configured to communicate with the UE (block 1510). For example, the UE (e.g., using communication manager 140 and/or transmission component 1704, depicted in FIG. 17) may transmit, to an ASF in an NR network, an initial request for aircraft mobility data, wherein the aircraft mobility data is associated with an aircraft configured to communicate with the UE, as described above.

As further shown in FIG. 15, in some aspects, process 1500 may include receiving, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an ADS-B server and the aircraft NR identifier, and wherein the aircraft number is an aircraft flight number or an aircraft registration number (block 1520). For example, the UE (e.g., using communication manager 140 and/or reception component 1702, depicted in FIG. 17) may receive, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an ADS-B server and the aircraft NR identifier, and wherein the aircraft number is an aircraft flight number or an aircraft registration number, as described above.

As further shown in FIG. 15, in some aspects, process 1500 may include performing an action based at least in part on the aircraft mobility data (block 1530). For example, the UE (e.g., using communication manager 140 and/or action component 1708, depicted in FIG. 17) may perform an action based at least in part on the aircraft mobility data, as described above.

Process 1500 may include additional aspects, such as any single aspect or any combination of aspects described below and/or in connection with one or more other processes described elsewhere herein.

In a first aspect, process 1500 includes transmitting the initial request to the ASF via one or more of a network node or an AMF.

In a second aspect, alone or in combination with the first aspect, process 1500 includes receiving, from an AMF in the NR network, an AMF notice indicating that the UE is within a defined distance from an edge of a terrestrial network, wherein the initial request is transmitted based at least in part on the AMF notice, and the initial request is transmitted in accordance with a request periodicity that is based at least in part on a downlink signal measurement.

In a third aspect, alone or in combination with one or more of the first and second aspects, process 1500 includes determining whether the UE is within a coverage area of the aircraft based at least in part on the aircraft mobility data and transmitting a message based at least in part on a determination that the UE is within the coverage area of the aircraft, or adopting a timing advance and frequency compensation based at least in part on the aircraft mobility data.

In a fourth aspect, alone or in combination with one or more of the first through third aspects, the ASF is associated with an application function or a third-party server.

In a fifth aspect, alone or in combination with one or more of the first through fourth aspects, the aircraft mobility data is received from the ADS-B server based at least in part on a request for aircraft mobility data transmitted to the ADS-B server, wherein the request is based at least in part on the initial request from the UE.

In a sixth aspect, alone or in combination with one or more of the first through fifth aspects, the initial request indicates a reference position associated with the UE and a radius associated with the reference position, and the radius indicates a maximum range between the aircraft and the UE.

In a seventh aspect, alone or in combination with one or more of the first through sixth aspects, the initial request indicates the aircraft NR identifier associated with the aircraft.

In an eighth aspect, alone or in combination with one or more of the first through seventh aspects, process 1500 includes receiving the aircraft mobility data via an NEF in the NR network that is associated with the mapping between the aircraft number and the aircraft NR identifier.

In a ninth aspect, alone or in combination with one or more of the first through eighth aspects, the aircraft is an aircraft UE, and the mapping between the aircraft number and the aircraft NR identifier is based at least in part on a mapping between the aircraft registration number and an IMSI or a GUTI; the aircraft is an aircraft network node, and the mapping between the aircraft number and the aircraft NR identifier is based at least in part on a mapping between the aircraft registration number and a global network node identifier; the aircraft is an aircraft network node DU, and the mapping between the aircraft number and the aircraft NR identifier is based at least in part on a mapping between the aircraft registration number, and a global network node identifier and a network node DU identifier; the aircraft is an aircraft IAB, and the mapping between the aircraft number and the aircraft NR identifier is based at least in part on a mapping between the aircraft registration number and a global IAB identifier; the aircraft is an aircraft repeater, and the mapping between the aircraft number and the aircraft NR identifier is based at least in part on a mapping between the aircraft registration number and a global repeater identifier; or the aircraft is an aircraft relay, and the mapping between the aircraft number and the aircraft NR identifier is based at least in part on a mapping between the aircraft registration number and a global relay identifier.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be an ASF in an NR network, or an ASF in an NR network may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 150. The communication manager 150 may include a filter component 1608, among other examples.

In some aspects, the apparatus 1600 may be configured to perform one or more operations described herein in connection with FIGS. 6-13. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the ASF described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the ASF described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the ASF described in connection with FIG. 2. In some aspects, the transmission component 1604 may be co-located with the reception component 1602 in a transceiver.

The transmission component 1604 may transmit, to an ADS-B server, a request for aircraft mobility data, wherein the aircraft mobility data is associated with an aircraft configured to communicate with a UE. The reception component 1602 may receive, from the ADS-B server and based at least in part on the request, the aircraft mobility data, wherein the aircraft mobility data indicates an aircraft number associated with the aircraft, and wherein the aircraft number is an aircraft flight number or an aircraft registration number. The transmission component 1604 may transmit, to the UE, the aircraft mobility data, wherein the aircraft mobility data indicates an aircraft NR identifier, and wherein the aircraft NR identifier is based at least in part on a mapping between the aircraft number and the aircraft NR identifier.

The reception component 1602 may receive, from an AMF in the NR network, an initial request for the aircraft mobility data, wherein the initial request originates at one of the UE, a network node, or the AMF, and the request is transmitted to the ADS-B server based at least in part on the initial request received at the ASF in the NR network. The filter component 1608 may filter the aircraft mobility data associated with the aircraft number based at least in part on a reference position and a radius associated with the reference position. The reception component 1602 may receive, from an AMF in the NR network, an initial request for the aircraft mobility data, wherein the initial request originates at the AMF according to a schedule.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a UE, or a UE may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 140. The communication manager 140 may include an action component 1708, among other examples.

In some aspects, the apparatus 1700 may be configured to perform one or more operations described herein in connection with FIGS. 6-13. Additionally, or alternatively, the apparatus 1700 may be configured to perform one or more processes described herein, such as process 1500 of FIG. 15. In some aspects, the apparatus 1700 and/or one or more components shown in FIG. 17 may include one or more components of the UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the UE described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the UE described in connection with FIG. 2. In some aspects, the transmission component 1704 may be co-located with the reception component 1702 in a transceiver.

The transmission component 1704 may transmit, to an ASF in an NR network, an initial request for aircraft mobility data, wherein the aircraft mobility data is associated with an aircraft configured to communicate with the UE. The reception component 1702 may receive, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an ADS-B server and the aircraft NR identifier, and wherein the aircraft number is an aircraft flight number or an aircraft registration number. The action component 1708 may perform an action based at least in part on the aircraft mobility data.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by an aircraft surveillance function (ASF) in a New Radio (NR) network, comprising: transmitting, to an automatic dependent surveillance broadcast (ADS-B) server, a request for aircraft mobility data, wherein the aircraft mobility data is associated with an aircraft configured to communicate with a user equipment (UE); receiving, from the ADS-B server and based at least in part on the request, the aircraft mobility data, wherein the aircraft mobility data indicates an aircraft number associated with the aircraft, and wherein the aircraft number is an aircraft flight number or an aircraft registration number; and transmitting, to the UE, the aircraft mobility data, wherein the aircraft mobility data indicates an aircraft NR identifier, and wherein the aircraft NR identifier is based at least in part on a mapping between the aircraft number and the aircraft NR identifier.

Aspect 2: The method of Aspect 1, wherein the ASF is associated with an application function or a third-party server.

Aspect 3: The method of any of Aspects 1 through 2, further comprising: receiving, from an access and mobility management function (AMF) in the NR network, an initial request for the aircraft mobility data, wherein the initial request originates at one of the UE, a network node, or the AMF, and wherein the request is transmitted to the ADS-B server based at least in part on the initial request received at the ASF.

Aspect 4: The method of Aspect 3, wherein the initial request indicates a reference position associated with the UE and a radius associated with the reference position, and wherein the radius indicates a maximum range between the aircraft and the UE.

Aspect 5: The method of Aspect 3, wherein the initial request indicates the aircraft NR identifier associated with the aircraft.

Aspect 6: The method of Aspect 3, wherein the initial request is received from the UE based at least in part on an AMF notice to the UE indicating that the UE is within a defined distance from an edge of a terrestrial network, and wherein the initial request is received in accordance with a request periodicity that is based at least in part on a downlink signal measurement.

Aspect 7: The method of any of Aspects 1 through 6, further comprising: filtering the aircraft mobility data associated with the aircraft number based at least in part on a reference position and a radius associated with the reference position.

Aspect 8: The method of any of Aspects 1 through 7, wherein transmitting the aircraft mobility data comprises transmitting the aircraft mobility data to a network exposure function (NEF) in the NR network for the mapping between the aircraft number and the aircraft NR identifier.

Aspect 9: The method of any of Aspects 1 through 8, wherein transmitting the aircraft mobility data comprises transmitting, to an access and mobility management function (AMF) in the NR network, the aircraft mobility data requested from the ADS-B server based at least in part on a schedule and not according to an initial request for the aircraft mobility data received from one of the AMF, a network node, or the UE.

Aspect 10: The method of any of Aspects 1 through 9, further comprising: receiving, from an access and mobility management function (AMF) in the NR network, an initial request for the aircraft mobility data, wherein the initial request originates at the AMF according to a schedule.

Aspect 11: The method of any of Aspects 1 through 10, wherein: the aircraft is an aircraft UE, and the mapping between the aircraft number and the aircraft NR identifier is based at least in part on a mapping between the aircraft registration number and an international mobile subscriber identity or a global unique temporary identifier; the aircraft is an aircraft network node, and the mapping between the aircraft number and the aircraft NR identifier is based at least in part on a mapping between the aircraft registration number and a global network node identifier; the aircraft is an aircraft network node distributed unit (DU), and the mapping between the aircraft number and the aircraft NR identifier is based at least in part on a mapping between the aircraft registration number, and a global network node identifier and a network node DU identifier; the aircraft is an aircraft integrated access and backhaul (IAB), and the mapping between the aircraft number and the aircraft NR identifier is based at least in part on a mapping between the aircraft registration number and a global IAB identifier, the aircraft is an aircraft repeater, and the mapping between the aircraft number and the aircraft NR identifier is based at least in part on a mapping between the aircraft registration number and a global repeater identifier; or the aircraft is an aircraft relay, and the mapping between the aircraft number and the aircraft NR identifier is based at least in part on a mapping between the aircraft registration number and a global relay identifier.

Aspect 12: A method of wireless communication performed by a user equipment (UE), comprising: transmitting, to an aircraft surveillance function (ASF) in a New Radio (NR) network, an initial request for aircraft mobility data, wherein the aircraft mobility data is associated with an aircraft configured to communicate with the UE; receiving, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an automatic dependent surveillance broadcast (ADS-B) server and the aircraft NR identifier, and wherein the aircraft number is an aircraft flight number or an aircraft registration number, and performing an action based at least in part on the aircraft mobility data.

Aspect 13: The method of Aspect 12, wherein transmitting the initial request comprises transmitting the initial request to the ASF via one or more of a network node or an access and mobility management function.

Aspect 14: The method of any of Aspects 12 through 13, further comprising: receiving, from an access and mobility management function (AMF) in the NR network, an AMF notice indicating that the UE is within a defined distance from an edge of a terrestrial network, wherein the initial request is transmitted based at least in part on the AMF notice, and wherein the initial request is transmitted in accordance with a request periodicity that is based at least in part on a downlink signal measurement.

Aspect 15: The method of any of Aspects 12 through 14, wherein performing the action comprises: determining whether the UE is within a coverage area of the aircraft based at least in part on the aircraft mobility data and transmitting a message based at least in part on a determination that the UE is within the coverage area of the aircraft; or adopting a timing advance and frequency compensation based at least in part on the aircraft mobility data.

Aspect 16: The method of any of Aspects 12 through 15, wherein the ASF is associated with an application function or a third-party server.

Aspect 17: The method of any of Aspects 12 through 16, wherein the aircraft mobility data is received from the ADS-B server based at least in part on a request for aircraft mobility data transmitted to the ADS-B server, wherein the request is based at least in part on the initial request from the UE.

Aspect 18: The method of any of Aspects 12 through 17, wherein the initial request indicates a reference position associated with the UE and a radius associated with the reference position, and wherein the radius indicates a maximum range between the aircraft and the UE.

Aspect 19: The method of any of Aspects 12 through 18, wherein the initial request indicates the aircraft NR identifier associated with the aircraft.

Aspect 20: The method of any of Aspects 12 through 19, wherein receiving the aircraft mobility data comprises receiving the aircraft mobility data via a network exposure function (NEF) in the NR network that is associated with the mapping between the aircraft number and the aircraft NR identifier.

Aspect 21: The method of any of Aspects 12 through 20, wherein: the aircraft is an aircraft UE, and the mapping between the aircraft number and the aircraft NR identifier is based at least in part on a mapping between the aircraft registration number and an international mobile subscriber identity or a global unique temporary identifier; the aircraft is an aircraft network node, and the mapping between the aircraft number and the aircraft NR identifier is based at least in part on a mapping between the aircraft registration number and a global network node identifier; the aircraft is an aircraft network node distributed unit (DU), and the mapping between the aircraft number and the aircraft NR identifier is based at least in part on a mapping between the aircraft registration number, and a global network node identifier and a network node DU identifier; the aircraft is an aircraft integrated access and backhaul (IAB), and the mapping between the aircraft number and the aircraft NR identifier is based at least in part on a mapping between the aircraft registration number and a global IAB identifier; the aircraft is an aircraft repeater, and the mapping between the aircraft number and the aircraft NR identifier is based at least in part on a mapping between the aircraft registration number and a global repeater identifier; or the aircraft is an aircraft relay, and the mapping between the aircraft number and the aircraft NR identifier is based at least in part on a mapping between the aircraft registration number and a global relay identifier.

Aspect 22: An apparatus for wireless communication at a device, comprising a processor; memory coupled with the processor; and instructions stored in the memory and executable by the processor to cause the apparatus to perform the method of one or more of Aspects 1-11.

Aspect 23: A device for wireless communication, comprising a memory and one or more processors coupled to the memory, the one or more processors configured to perform the method of one or more of Aspects 1-11.

Aspect 24: An apparatus for wireless communication, comprising at least one means for performing the method of one or more of Aspects 1-11.

Aspect 25: A non-transitory computer-readable medium storing code for wireless communication, the code comprising instructions executable by a processor to perform the method of one or more of Aspects 1-11.

Aspect 26: A non-transitory computer-readable medium storing a set of instructions for wireless communication, the set of instructions comprising one or more instructions that, when executed by one or more processors of a device, cause the device to perform the method of one or more of Aspects 1-11.

Aspect 27: An apparatus for wireless communication at a device, comprising a processor; memory coupled with the processor; and instructions stored in the memory and executable by the processor to cause the apparatus to perform the method of one or more of Aspects 12-21.

Aspect 28: A device for wireless communication, comprising a memory and one or more processors coupled to the memory, the one or more processors configured to perform the method of one or more of Aspects 12-21.

Aspect 29: An apparatus for wireless communication, comprising at least one means for performing the method of one or more of Aspects 12-21.

Aspect 30: A non-transitory computer-readable medium storing code for wireless communication, the code comprising instructions executable by a processor to perform the method of one or more of Aspects 12-21.

Aspect 31: A non-transitory computer-readable medium storing a set of instructions for wireless communication, the set of instructions comprising one or more instructions that, when executed by one or more processors of a device, cause the device to perform the method of one or more of Aspects 12-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at an aircraft surveillance function (ASF) in a New Radio (NR) network, comprising:
a memory; and
one or more processors, coupled to the memory, configured to:
transmit, to an automatic dependent surveillance broadcast (ADS-B) server, a request for aircraft mobility data, wherein the aircraft mobility data is associated with an aircraft configured to communicate with a user equipment (UE);
receive, from the ADS-B server and based at least in part on the request, the aircraft mobility data, wherein the aircraft mobility data indicates an aircraft number associated with the aircraft, and wherein the aircraft number is an aircraft flight number or an aircraft registration number; and
transmit, to the UE, the aircraft mobility data, wherein the aircraft mobility data indicates an aircraft NR identifier, and wherein the aircraft NR identifier is based at least in part on a mapping between the aircraft number and the aircraft NR identifier.

2. The apparatus of claim 1, wherein the ASF is associated with an application function or a third-party server.

3. The apparatus of claim 1, wherein the one or more processors are further configured to:
receive, from an access and mobility management function (AMF) in the NR network, an initial request for the aircraft mobility data, wherein the initial request originates at one of the UE, a network node, or the AMF, and wherein the request is transmitted to the ADS-B server based at least in part on the initial request received at the ASF.

4. The apparatus of claim 3, wherein the initial request indicates a reference position associated with the UE and a radius associated with the reference position, and wherein the radius indicates a maximum range between the aircraft and the UE.

5. The apparatus of claim 3, wherein the initial request indicates the aircraft NR identifier associated with the aircraft.

6. The apparatus of claim 3, wherein the initial request is received from the UE based at least in part on an AMF notice to the UE indicating that the UE is within a defined distance from an edge of a terrestrial network, and wherein the initial request is received in accordance with a request periodicity that is based at least in part on a downlink signal measurement.

7. The apparatus of claim 1, wherein the one or more processors are further configured to:
filter the aircraft mobility data associated with the aircraft number based at least in part on a reference position and a radius associated with the reference position.

8. The apparatus of claim 1, wherein the one or more processors, to transmit the aircraft mobility data, are configured to transmit the aircraft mobility data to a network exposure function (NEF) in the NR network for the mapping between the aircraft number and the aircraft NR identifier.

9. The apparatus of claim 1, wherein the one or more processors are further configured to:
receive, from an access and mobility management function (AMF) in the NR network, an initial request for the aircraft mobility data, wherein the initial request originates at the AMF according to a schedule.

10. The apparatus of claim 1, wherein the one or more processors are configured to transmit, to an access and mobility management function (AMF) in the NR network, the aircraft mobility data requested from the ADS-B server based at least in part on a schedule and not according to an initial request for the aircraft mobility data received from one of the AMF, a network node, or the UE.

11. The apparatus of claim 1, wherein:
the aircraft is an aircraft UE, and the mapping between the aircraft number and the aircraft NR identifier is based at least in part on a mapping between the aircraft registration number and an international mobile subscriber identity or a global unique temporary identifier;
the aircraft is an aircraft network node, and the mapping between the aircraft number and the aircraft NR identifier is based at least in part on a mapping between the aircraft registration number and a global network node identifier;
the aircraft is an aircraft network node distributed unit (DU), and the mapping between the aircraft number and the aircraft NR identifier is based at least in part on a mapping between the aircraft registration number, and a global network node identifier and a network node DU identifier;
the aircraft is an aircraft integrated access and backhaul (IAB), and the mapping between the aircraft number and the aircraft NR identifier is based at least in part on a mapping between the aircraft registration number and a global IAB identifier;
the aircraft is an aircraft repeater, and the mapping between the aircraft number and the aircraft NR identifier is based at least in part on a mapping between the aircraft registration number and a global repeater identifier; or
the aircraft is an aircraft relay, and the mapping between the aircraft number and the aircraft NR identifier is based at least in part on a mapping between the aircraft registration number and a global relay identifier.

12. An apparatus for wireless communication at a user equipment (UE), comprising:
a memory; and
one or more processors, coupled to the memory, configured to:
transmit, to an aircraft surveillance function (ASF) in a New Radio (NR) network, an initial request for aircraft mobility data, wherein the aircraft mobility data is associated with an aircraft configured to communicate with the UE;
receive, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an automatic dependent surveillance broadcast (ADS-B) server and the aircraft NR identifier, and wherein the aircraft number is an aircraft flight number or an aircraft registration number; and
perform an action based at least in part on the aircraft mobility data.

13. The apparatus of claim 12, wherein the one or more processors, to transmit the initial request, are configured to transmit the initial request to the ASF via one or more of a network node or an access and mobility management function.

14. The apparatus of claim 12, wherein the one or more processors are further configured to:
receive, from an access and mobility management function (AMF) in the NR network, an AMF notice indicating that the UE is within a defined distance from an edge of a terrestrial network, wherein the initial request is transmitted based at least in part on the AMF notice, and wherein the initial request is transmitted in accordance with a request periodicity that is based at least in part on a downlink signal measurement.

15. The apparatus of claim 12, wherein the one or more processors, to perform the action, are configured to:
determine whether the UE is within a coverage area of the aircraft based at least in part on the aircraft mobility data and transmit a message based at least in part on a determination that the UE is within the coverage area of the aircraft; or
adopt a timing advance and frequency compensation based at least in part on the aircraft mobility data.

16. The apparatus of claim 12, wherein the ASF is associated with an application function or a third-party server.

17. The apparatus of claim 12, wherein the aircraft mobility data is received from the ADS-B server based at least in part on a request for aircraft mobility data transmitted to the ADS-B server, wherein the request is based at least in part on the initial request from the UE.

18. The apparatus of claim 12, wherein the initial request indicates a reference position associated with the UE and a radius associated with the reference position, and wherein the radius indicates a maximum range between the aircraft and the UE.

19. The apparatus of claim 12, wherein the initial request indicates the aircraft NR identifier associated with the aircraft.

20. The apparatus of claim 12, wherein the one or more processors, to receive the aircraft mobility data, are configured to receive the aircraft mobility data via a network exposure function (NEF) in the NR network that is associated with the mapping between the aircraft number and the aircraft NR identifier.

21. The apparatus of claim 12, wherein:
the aircraft is an aircraft UE, and the mapping between the aircraft number and the aircraft NR identifier is based at least in part on a mapping between the aircraft registration number and an international mobile subscriber identity or a global unique temporary identifier;
the aircraft is an aircraft network node, and the mapping between the aircraft number and the aircraft NR identifier is based at least in part on a mapping between the aircraft registration number and a global network node identifier;
the aircraft is an aircraft network node distributed unit (DU), and the mapping between the aircraft number and the aircraft NR identifier is based at least in part on a mapping between the aircraft registration number, and a global network node identifier and a network node DU identifier;
the aircraft is an aircraft integrated access and backhaul (IAB), and the mapping between the aircraft number and the aircraft NR identifier is based at least in part on a mapping between the aircraft registration number and a global IAB identifier;
the aircraft is an aircraft repeater, and the mapping between the aircraft number and the aircraft NR identifier is based at least in part on a mapping between the aircraft registration number and a global repeater identifier; or
the aircraft is an aircraft relay, and the mapping between the aircraft number and the aircraft NR identifier is based at least in part on a mapping between the aircraft registration number and a global relay identifier.

22. A method of wireless communication performed by an aircraft surveillance function (ASF) in a New Radio (NR) network, comprising:
transmitting, to an automatic dependent surveillance broadcast (ADS-B) server, a request for aircraft mobility data, wherein the aircraft mobility data is associated with an aircraft configured to communicate with a user equipment (UE);
receiving, from the ADS-B server and based at least in part on the request, the aircraft mobility data, wherein the aircraft mobility data indicates an aircraft number associated with the aircraft, and wherein the aircraft number is an aircraft flight number or an aircraft registration number; and
transmitting, to the UE, the aircraft mobility data, wherein the aircraft mobility data indicates an aircraft NR identifier, and wherein the aircraft NR identifier is based at least in part on a mapping between the aircraft number and the aircraft NR identifier.

23. The method of claim 22, further comprising:
receiving, from an access and mobility management function (AMF) in the NR network, an initial request for the aircraft mobility data, wherein the initial request originates at one of the UE, a network node, or the AMF, and wherein the request is transmitted to the ADS-B server based at least in part on the initial request received at the ASF.

24. The method of claim 22, further comprising:
filtering the aircraft mobility data associated with the aircraft number based at least in part on a reference position and a radius associated with the reference position.

25. The method of claim 22, wherein transmitting the aircraft mobility data comprises transmitting the aircraft mobility data to a network exposure function (NEF) in the NR network for the mapping between the aircraft number and the aircraft NR identifier.

26. A method of wireless communication performed by a user equipment (UE), comprising:
transmitting, to an aircraft surveillance function (ASF) in a New Radio (NR) network, an initial request for aircraft mobility data, wherein the aircraft mobility data is associated with an aircraft configured to communicate with the UE;
receiving, from the ASF and based at least in part on the initial request, aircraft mobility data, wherein the aircraft mobility data indicates an aircraft NR identifier associated with the aircraft, wherein the aircraft NR identifier is based at least in part on a mapping between an aircraft number indicated by an automatic dependent surveillance broadcast (ADS-B) server and the aircraft NR identifier, and wherein the aircraft number is an aircraft flight number or an aircraft registration number; and
performing an action based at least in part on the aircraft mobility data.

27. The method of claim 26, wherein transmitting the initial request comprises transmitting the initial request to the ASF via one or more of a network node or an access and mobility management function.

28. The method of claim 26, further comprising:
receiving, from an access and mobility management function (AMF) in the NR network, an AMF notice indicating that the UE is within a defined distance from an edge of a terrestrial network, wherein the initial request is transmitted based at least in part on the AMF notice, and wherein the initial request is transmitted in accordance with a request periodicity that is based at least in part on a downlink signal measurement.

29. The method of claim 26, wherein performing the action comprises:
determining whether the UE is within a coverage area of the aircraft based at least in part on the aircraft mobility data and transmitting a message based at least in part on a determination that the UE is within the coverage area of the aircraft; or
adopting a timing advance and frequency compensation based at least in part on the aircraft mobility data.

30. The method of claim 26, wherein receiving the aircraft mobility data comprises receiving the aircraft mobility data via a network exposure function (NEF) in the NR network that is associated with the mapping between the aircraft number and the aircraft NR identifier.
